(19) United States
(12) Patent Application Publication
(10) Pub. No.: US 2026/0300626 A1
(43) Pub. Date: Oct. 1, 2026

(54) SYSTEMS AND METHODS FOR INCREASING CONTEXT LENGTH OF A LANGUAGE MODEL

(71) Applicant: Samsung Electronics Co., Ltd., Suwon-si (KR)

(72) Inventors: Sai Prahladh Padmanabhan, San Jose, CA (US); Chiho Choi, San Jose, CA (US); Joon Hee Choi, Campbell, CA (US)

(21) Appl. No.: 19/265,460

(22) Filed: Jul. 10, 2025

Related U.S. Application Data
(60) Provisional application No. 63/781,240, filed on Mar. 31, 2025.

(51) Int. Cl. G06F 40/284; G06F 40/30

(52) U.S. Cl. CPC G06F 40/284; G06F 40/30

(57) ABSTRACT

Systems and methods for increasing context length of a language model are disclosed. A first token associated with a language model is identified. The importance of the first token is detected to be below a threshold importance. A semantic shift of the first token is further detected. A first representation of the first token is stored in the storage device based on determining the importance of the first token and further based on identifying the semantic shift. A trigger is detected. A first representation of the first token is retrieved from the storage device based on detecting the trigger. The first representation of the first token is combined with one or more second representations of one or more second tokens associated with an active context.

### CROSS-REFERENCE TO RELATED APPLICATION(S)

The present application claims priority to and the benefit of U.S. Provisional Application No. 63/781,240 filed Mar. 31, 2025, entitled “INCREASING LARGE LANGUAGE MODEL (LLM) CONTEXT LENGTH BY OFFLOADING TOKENS WITH LOW CONTEXT IMPORTANCE,” the entire content of which is incorporated herein by reference.

### FIELD

One or more aspects of embodiments according to the present disclosure relate to machine learning, and more particularly to increasing the context length of a language model.

### BACKGROUND

The use of artificial intelligence (AI) has increased dramatically over the last few years. AI has become commonly used in domains such as image classification, speech recognition, media analytics, heath care, autonomous machines, smart assistants, and the like. Using AI often necessitates the use of large datasets and advanced algorithms and that similarly necessitate efficient and cost-effective data processing solutions.

The above information disclosed in this Background section is only for enhancement of understanding of the background of the present disclosure, and therefore, it may contain information that does not form prior art.

### SUMMARY

One or more embodiments of the present disclosure are directed to a system comprising a processor, a storage device, and a memory. The memory stores instructions that, when executed by the processor, cause the processor to: identify a first token associated with a language model; detect importance of the first token being below a threshold importance; detect a semantic shift of the first token; store a first representation of the first token in the storage device based on determining the importance of the first token and further based on identifying the semantic shift; detect a trigger; retrieve the first representation of the first token from the storage device based on detecting the trigger; and combine the first representation of the first token with one or more second representations of one or more second tokens associated with an active context.

In some embodiments, the storage device includes a first type of storage medium and a second type of storage medium slower than the first type of storage medium, wherein the instructions further cause the processor to store the first token to the first type of storage medium and a third token to the second type of storage medium based on determining higher importance of the first token relative to the third token.

In some embodiments, the first representation of the first token includes a vector representation of the first token for identifying relationship of the first token relative to one or more third tokens.

In some embodiments, the instructions that cause the processor to determine the importance of the first token include instructions that cause the processor to calculate an attention score for the first token based on the first representation of the first token.

In some embodiments, the attention score for the first token is based on a first attention score generated by a first portion of the language model and a second attention score generated by a second portion of the language model.

In some embodiments, the first portion and the second portion include a first layer and a second layer of the language model.

In some embodiments, the first portion and the second portion include a first attention head and a second attention head of the language model.

In some embodiments, the instructions that cause the processor to identify the semantic shift include instructions that cause the processor to: compute a distance between the first representation of the first token associated with a first portion of an interaction, and a second representation of a third token associated with a second portion of the interaction; and determine that the distance is greater than a threshold distance.

In some embodiments, the trigger includes a determination that the first token has semantic relevance to the one or more second tokens associated with the active context.

In some embodiments, the instructions further cause the processor to: based on combining the first representation of the first token, compute an attention score for the first token based on the one or more second representations and the first representation.

One or more embodiments of the present disclosure are also directed to a method that includes: identifying, by a processor, a first token associated with a language model; detecting, by the processor, importance of the first token being below a threshold importance; detecting, by the processor, a semantic shift of the first token; storing, by the processor, a first representation of the first token in a storage device coupled to the processor based on determining the importance of the first token and further based on identifying the semantic shift; detecting, by the processor, a trigger; retrieving, by the processor, the first representation of the first token from the storage device based on detecting the trigger; and combining, by the processor, the first representation of the first token with one or more second representations of one or more second tokens associated with an active context.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a block diagram of a system for executing a machine learning model according to one or more embodiments;

FIG. 2 depicts a block diagram of an LLM executed by a processor according to one or more embodiments;

FIG. 3 depicts a block diagram of example attention matrices for an LLM having two layers and two attention heads according to one or more embodiments;

FIG. 4 is a conceptual diagram of example tokens generated during an interaction according to one or more embodiments of the present disclosure;

FIG. 5 depicts a flow diagram of a process for increasing context length of a language model according to one or more embodiments;

FIG. 6 depicts a flow diagram of a process for selecting candidate tokens for offloading based on importance according to one or more embodiments;

FIG. 7 depicts a flow diagram of a process for computing drift of a token according to one or more embodiments; and

FIG. 8 depicts a flow diagram of a process for reintegrating an offloaded token back into an active context or context length according to one or more embodiments.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

In addition, a feature of embodiments of the present disclosure may be combined or combined with one or more other features, partially or entirely, and may be operated in various ways, and an embodiment may be implemented independently of one or more other embodiments, or in conjunction with the one or more other embodiments.

The field of artificial intelligence (AI) has witnessed vast advancement in the field of language models. The increased use of language models in a variety of natural language processing tasks have helped the advancement of related AI-based services.

In the context of a large language model (LLM), context length refers to a maximum number of tokens (e.g., words, subwords, characters, or the like) that the model can process in an interaction. Both input tokens (e.g., an input prompt to the LLM), and output tokens (responses generated by the LLM) are included in computing the context length. A larger context length may allow the LLM to consider or “remember” more information, which may improve its ability to understand and generate text that is more coherent and relevant.

During training, the model may be designed with a fixed maximum context length (e.g., 512 tokens). A size of an attention matrix that is used by the model to make predictions may depend on the context length. In this regard, the attention matrix may be sized as an N×N matrix, where N is the context length.

As a conversation progresses with the LLM, the context length may exceed the allowed maximum. One way to handle this problem may be to discard older tokens associated with older portions of the conversation history to make room for newer tokens associated with more recent portions of the conversation. Discarding tokens, however, may limit the model's accuracy in answering questions relating to relatively older data associated with an older context of the conversation.

A longer context length may allow the model to handle more extensive prompts or dialogues. A longer context may also support applications like summarizing books, writing code based on detailed instructions, or reasoning over long documents, all of which may cause the maximum context length to be exceeded. Thus, another solution to the problem of limited context length may be to set an overly lengthy context length. Doing so, however, may pose some practical limitations. For example, the quadratic scaling of the attention matrix for very large contexts may place stress on the device processing the matrix. Training a model with such a large context length may warrant input sequences of that length during training. The dataset used for training may not have a sufficiently long example, and padding the dataset to create such an example may degrade the model's performance. Furthermore, a positional encoding method used by the model may be designed for a specific maximum context length, and extending the context length may involve redesigning the positional encoding method.

In general terms, embodiments of the present disclosure are directed to increasing (or emulating the increase of) the context length of a language model beyond the maximum context length designated for the model (e.g., during training). In some embodiments, a context monitor is configured to monitor importance and/or relevance of tokens during a conversation session or interaction, and offload one or more of the tokens determined to have less importance and/or relevance (collectively referred to as less relevant) with respect to a current or active context, to a secondary memory. In some embodiments, the more important ones of the offloaded tokens are stored in a faster memory (e.g., dynamic random access memory (DRAM)), and the remaining offloaded tokens are stored in slower memory (e.g., NAND flash).

An offloaded token may be retrieved from the secondary memory and re-integrated to the model's active context when the offloaded token becomes relevant again to the active context. The reintegration of offloaded tokens to the active context allows the offloaded tokens to be considered in generating responses by the model, giving the impression of an increased context length without modifying the model's architecture to physically increase the size of the context length, and without having to retrain the model with an increased number of tokens. The offloading of tokens instead of discarding or truncating them to make room for new tokens may increase accuracy of responses by the model.

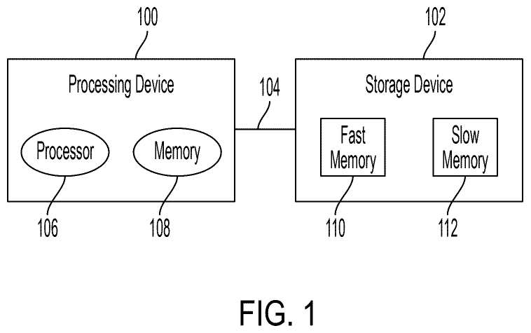

FIG. 1 depicts a block diagram of a system for executing a machine learning model according to one or more embodiments. The system includes a processing device 100 coupled to a storage device 102 over a data communications link 104. The data communication link 104 may include, for example, a compute express link (CXL) bus, peripheral component interconnect express (PCIe) bus, Ethernet, Universal Serial Bus (USB), and/or any wired or wireless data communication link or network.

The processing device 100 may include a processor 106 and a memory 108. The processor 106 may include circuitry such as one or more central processing units (CPUs), graphics processing units (GPUs), tensor processing units (TPUs), microcontrollers, digital signal processors (DSPs), coprocessors, application-specific integrated circuits (ASICs), field programmable gate arrays (FPGAs), hard-wired logic, and/or analog circuitry.

The memory 108 may include volatile and/or nonvolatile memory, such as, for example, random access memory (RAM), dynamic random access memory (DRAM), static random access memory (SRAM), and/or the like. The memory 108 may store instructions for allowing the processor 106 to execute a machine learning model and associated context monitor.

In some embodiments, the storage device 102 is a secondary storage such as, for example, a CXL Memory Module-Hybrid (CMM-H) type device that combines DRAM and NAND flash memory on a CXL interface. The storage device 102 may include one or more memory or storage medium such as, for example, a fast or faster memory 110 and a slow or slower memory 112. The fast memory 110 may take the form of a DRAM, high-bandwidth memory (HBM), and/or any other type of memory with an access latency that is lower than the access latency of the slow memory 112. The slow memory may take the form of a NAND flash or non-volatile memory.

In some embodiments, the slow memory 112 and the fast memory 110 are part of a tiered memory hierarchy where storage media accessible to the processing device 100 are organized based on their access and response times. A storage medium in the hierarchy may be deemed to be a slow or slower memory, or a fast or faster memory, relative to other storage media in the memory hierarchy, depending on a level or tier of the hierarchy assigned to the memory device.

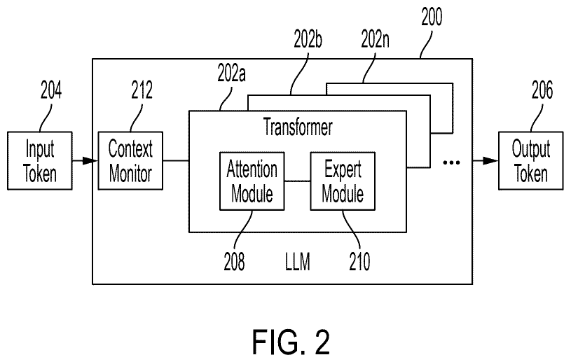

FIG. 2 depicts a block diagram of an LLM executed by the processor 106 according to one or more embodiments of the present disclosure. The LLM includes one or more (e.g., N) neural network layers 202a-202n (collectively referenced as 202) implemented as, for example, transformer layers. The neural network layers 202 may be configured to take an input token 204 and process and transform the input token 204 to generate an output token 206. For example, the input token 204 may be a word or a phrase, and the output token 206 may be a next word or phrase in a sequence that is predicted by the LLM based on the input token 204.

The layers 202 may be sequentially invoked to generate the output token 206. For example, a first layer 202a may process the input token 204 to generate a first output. The first output may be an input to a second layer 202b which may generate a second output based on the input. The other layers of the LLM 200 may be sequentially invoked until the output token 206 is generated.

In some embodiments, a neural network layer 202 includes an attention module 208 and an expert module 210. The attention module 208 may be configured to use a “self-attention” mechanism to analyze relationships between tokens, including the input token, to understand context by weighing the importance of each token relative to other tokens, regardless of their position in the sequence.

The expert module 210 may be configured to use the contextual information generated by the attention module 208 to transform the input data further to capture more complex relationships in the data. In some embodiments, the expert module 210 may invoke one or more experts or specialized machine learning models to refine the representation of the input data. In some embodiments, a subset of an available set of experts is selected based on an input token. The expert module 210 may use the refined representations to predict a next token of a sequence of tokens.

In some embodiments, the input token(s) and the tokens generated by one or more transformer layers may be tracked or maintained in association with a context length or window (used interchangeably herein). A group of tokens associated with the context length may define a current or active context of an interaction (e.g., a conversation) processed by the LLM. In some embodiments, the active context includes a sequence of tokens leading up to and including the most recent token, within the context window limit. In some embodiments, a start of a conversation for a user for an inference session is defined by a first token fed into the model as a prompt. An end of the conversation for the user may be defined when the context length has been exceeded, or an explicit token is detected that marks the end of the conversation. In some embodiments, a conversation may be an active chat session.

As the interaction progresses, certain tokens may no longer be relevant to the active context. For example, the interaction may begin with a discussion of apples and bananas, and transition to a discussion of Apple phones. In this case, the “banana” token which may be relevant to a context of fruits may no longer be relevant to a discussion where the context is mobile devices, and may not be needed to generate responses related to mobile devices. In this case, the “banana” token may be offloaded to the storage device 102.

In some embodiments, the LLM 200 includes a context monitor 212 configured to monitor tokens of a context length and identify tokens to be offloaded to the storage device 102. The context monitor 212 may be implemented in hardware, firmware (e.g., via an ASIC), and/or by a more general purpose hardware, such as a central processing unit (CPU) (e.g., the processor 106) configured to execute instructions stored in a non-transitory storage medium (e.g., the memory 108).

The offloading of the tokens by the context monitor 212 may allow new tokens to be added, or offloaded tokens that are relevant to the active context to be reintroduced, without exceeding the allotted context length size. The identification of tokens to be offloaded may be in addition or in lieu of timestamps associated with the tokens. In this regard, instead of or in addition to selecting tokens with the oldest timestamps to be offloaded to the storage device 102, the context monitor 212 may determine importance of the tokens in the active context, and further determine semantic relevance of the tokens to a currently generated (e.g., the most recent) token.

In some embodiments, importance of the tokens may be determined by computing an attention score of one or more of the tokens relative other tokens in the context length. The attention score may be computed for one or more (e.g., each) token in the context length across one or more neural network layers and/or one or more attention heads. The computed attention score for a token (i) relative the other tokens in the context length may be aggregated over the one or more neural network layers and one or more attention heads to identify a final or total attention score for token (i) according to the below formula:

$$Importance Token ( i ) = \frac{1}{H * L} {{\sum }_{l = 1}}^{L} {{\sum }_{h = 1}}^{H} {AttemtionWeight}_{l , h} ( i )$$

H: Number of attention heads
L: Number of layers

The tokens may be ranked according to the final attention scores, and the tokens with attention scores below a threshold attention or importance score may be identified as candidates for offloading to the storage device.

In some embodiments, semantic relevance of a token for an active context may be determined based on whether there has been a semantic shift (also referred to as an embedding drift) of a token based on a current embedding of the token. Detection of a shift may indicate that prior embeddings of the token are no longer semantically relevant to the active context. In some embodiments, an embedding drift is computed for tokens that are identified as polysemous words. A polysemous word may be a word that has more than one meaning or interpretation based on different contexts. For example, the word “key” be a polysemous word that may refer to a tool for unlocking a door, a solution to a problem, or the main feature, depending on the context in which it appears. In some embodiments, an embedding drift is computed for tokens other than polysemous words.

In some embodiments, a running mean of an embedding of a polysemous token is maintained over time. The running mean may be used to calculate the drift at a given timestamp t according to the following example formula:

$$drift [ token ] [ t ] = 1 - cosine ( embedding [ token ] [ t ] , running\_mean [ token ] )$$

$$where , running\_mean [ token ] = mean ( embedding [ token ] [ : t ] )$$

According to the above example formula, a drift of a token at timestamp t is determined based on a cosine similarity between the embedding of the token at time t and a mean of the embeddings of the token. As a person of skill in the art should recognize, other distance metrics other than cosine similarity may also be used. The prior embedding of tokens with the highest drift values may be candidates for offloading to the storage device 102.

In some embodiments, attention may be given higher weight in deciding whether a token is to be offloaded than drift. Attention may indicate which tokens are used at a specific step, and drift may indicate which tokens retain usable information over time. Even if a token is not attended to now, it might be attended to later. But if its embedding has drifted or degraded too much, the model may not be able to recover its value.

In some embodiments, a token may have low attention and low drift. Low attention score may indicate that a particular token is not being attended to as much. Low drift may indicate that the general trend of the topic still aligns with the semantic meaning of a particular token. For example, if the term “banana” was mentioned earlier in a conversation, but the conversation is now about different food items (not particularly fruits), the “banana” token may have both a low attention score and a low drift.

In some embodiments, the context monitor 212 is configured to select tokens with a high drift (e.g., drift above a threshold drift value) and a low attention score (e.g., an attention score below a threshold attention or importance value) as candidates for offloading to the storage device 102. In some embodiments, the candidate tokens for offloading may be sorted based on the attention scores, and the candidate tokens with the highest attention scores may be stored in the fast memory 110 (e.g., until the fast memory becomes full), and the remaining candidate tokens may be stored in the slow memory 112. In some embodiments, the candidate tokens for offloading may be sorted based on the attention scores, and the candidate tokens with the lowest drift values may be stored in the fast memory 110 (e.g., until the fast memory becomes full), and the remaining candidate tokens may be stored in the slow memory 112. In some embodiments, a combination of attention scores and drift values may be used to sort the candidate tokens to identify the candidate tokens to be stored in the fast memory 110 and the candidate tokens to be stored in the slow memory 112.

The context monitor 212 may store the embedding vectors of the identified token to be offloaded, along with associated metadata. For example, the metadata may include a computed attention score. The embedding vectors may be used to determine the meaning of the token in an older context.

In some embodiments, the context monitor 212 is configured to identify one or more of the offloaded tokens to be reintroduced to the context length. In this regard, as tokens currently in the context length are selected for being offloaded to the storage device 102, previously offloaded tokens that may now be relevant to the active context may be retrieved and added to the context length. In this manner, the context length may be deemed to be extended to take into account tokens that may, in other systems, been discarded.

In some embodiments, the context monitor 212 integrates an offloaded token by retrieving the embedding and metadata of the offloaded token from the storage device 102, and concatenating the retrieved embedding with the embeddings in the context length. In some embodiments, the context monitor 212 re-computes the attention scores for the tokens in the active context that contains the re-integrated token.

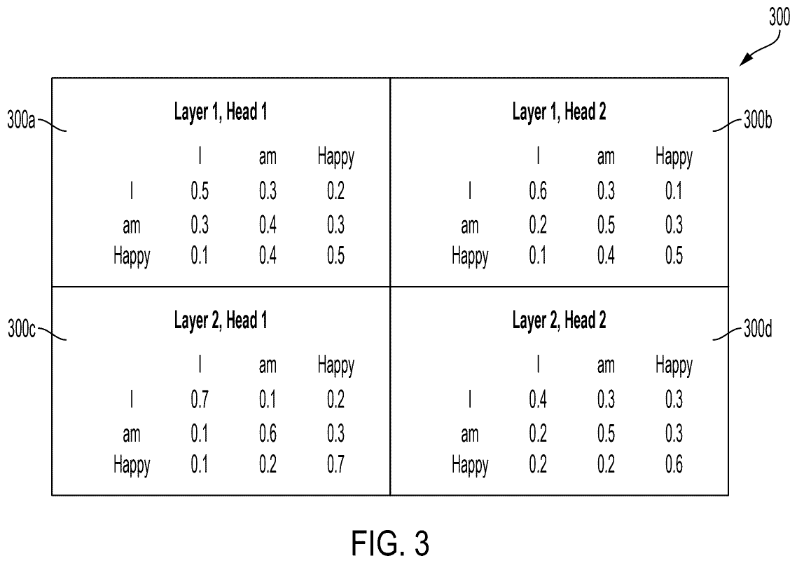

FIG. 3 depicts a block diagram of example attention matrices 300 for an LLM having two layers and two attention heads according to one or more embodiments. A first attention matrix 300a computes attention scores for tokens in the context length (e.g., “I,” “Am,” “Happy,” etc.) for a first network layer (e.g., the neural network layer 202) and a first attention head. A second attention matrix 300b computes attention scores for the same tokens for the first network layer and a second attention head. A third attention matrix 300c computes attention scores for the same tokens for a second network layer and the first attention head. A fourth attention matrix 300d computes attention scores for the same tokens for the second network layer and the second attention head. The attention score may be calculated using a dot-product between query and key vectors generated based on an input set of tokens. The query and key vectors may be derived based on learned query and key weight matrices.

In some embodiments, the importance of a token is computed by summing the attention scores for the token across one or more (e.g., all) of the network layers and heads. Taking the example of the token “Happy,” the total attention score for this token may be computed by summing the attention scores of all the columns corresponding to the token “Happy” across all the layers and heads as follows:

$$Layer 1 , Head 1 : 0.2 + 0.3 + 0.5 = 1.$$

$$Layer 1 , Head 2 : 0.1 + 0.3 + 0.5 = 0.9$$

$$Layer 2 , Head 1 : 0.2 + 0.3 + 0.7 = 1.2$$

$$Layer 2 , Head 2 : 0.3 + 0.3 + 0.6 = 1.2$$

$$Total Attention weight for “ Happy ” = 4.3$$

The computation may be repeated for all the tokens in the context length, and ranked based on the basis of importance or attention scores. One will understand that similar principles may be employed for any number of layers and attention heads.

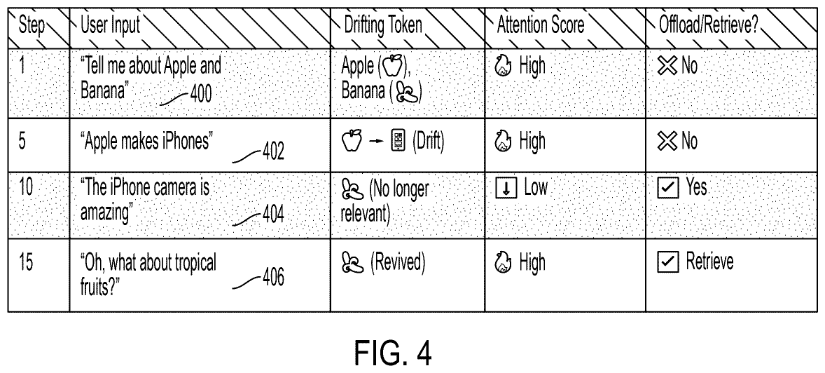

FIG. 4 is a conceptual diagram of example tokens generated during an interaction according to one or more embodiments of the present disclosure. In the example of FIG. 4, a first user input 400 to the LLM 200 (e.g., at step or timestamp 1) is “Tell me about Apple and Banana.” The “apple” token may be tracked for determining drift. The “banana” token may not need to be tracked for drift as “banana” is not polysemous. In this example, the attention scores of “apple” and “banana” are high (e.g., above a threshold) and thus, the “apple” and “banana” tokens are not candidates for offloading to the storage device 102.

A second input 402 to the LLM 200 (e.g., at step or timestamp 5) in the example of FIG. 4 is “Apple makes Phones.” A drift of the term “apple” may be determined by determining a distance metric between the embedding for the token “Apple” in the second input 402, and the embedding for the token “apple” in the first input 400. In this example, however, the attention score for “apple” is still deemed to be high. Thus, the “apple” token is not deemed to be a candidate for offloading to the storage device 102.

In step or timestamp 10, the conversation shifts from fruits to mobile devices, and a third input 404 to the LLM 200 is “The Phone camera is amazing.” The “banana” token is no longer present in the third input, and thus, not semantically relevant to the current context. In addition, the attention score for banana is also low. Thus, the “banana” token is identified as a candidate for offloading.

In step or timestamp 15, the conversation shifts back to fruits, and a fourth input 406 to the LLM is “Oh, what about tropical fruits?” The offloaded “banana” token is thus deemed to have a small drift with the embeddings of the current tokens. Thus, the offloaded “banana” token may be retrieved and added to the context length. In this regard, a soft-prompting technique may be employed where the retrieved token's embedding may be prepended to the input embeddings from the current context.

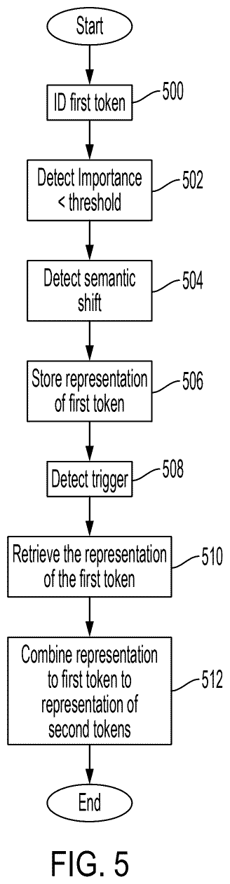

FIG. 5 depicts a flow diagram of a process for increasing context length of a language model according to one or more embodiments. Although the process is described with respect to one token, a person of skill in the art should recognize that the process may be invoked for one or more other tokens in the active context or context length.

The process starts, and in act 500, the context monitor 212 identifies a first token of a language model (e.g., the LLM 200). The first token may be part of the active context or context length.

In act 502, the context monitor 212 detects the importance of the first token as being below a threshold importance. In some embodiments, importance of the first token is determined by calculating an attention score for the first token based on a first representation of the first token. The first representation of the first token may include a vector representation (e.g., an embedding) of the first token, wherein the vector representation is for identifying relationship of the first token relative to one or more third tokens (e.g., other tokens in the context length).

The attention score for the first token may be based on a first attention score generated by a first portion of the language model and a second attention score generated by a second portion of the language model. In some embodiments, the first and second portions of the language model may include one or more transformer layers 202 of the LLM 200. In some embodiments, the first and second portions of the language model may include one or more attention heads. A token may be a candidate for offloading based on the attention score being below a threshold attention score.

In act 504, the context monitor 212 detects a semantic shift relative to the first token. In this regard, the context monitor 212 computes a distance between the first representation of the first token associated with a first portion of an interaction and a second representation of a third token associated with a second portion of the interaction, and determines that the distance is greater than a threshold distance. The first portion of the interaction may be an interaction at a first timestamp, and the second portions of the interaction may be an interaction at a second timestamp. In some embodiments, the first token is a polysemous word identified from a list of polysemous words.

In act 506 the first representation of the first token is stored in the storage device 102 based on determining the importance of the first token and further based on identifying the semantic shift. The storage device may include a first type of storage medium (e.g., the fast memory 110) and a second type of storage medium (e.g., the slow memory 112) slower than the first type of storage medium. The first token may be stored in the first type of storage medium and a third token in the second type of storage medium based on determining higher importance of the first token relative to the third token.

In act 508, the context monitor 212 detects a trigger for reintroducing the offloaded first token back into the active context. In this regard, the context monitor 212 may perform evaluation of one or more offloaded tokens for possible reintroduction into the active context. The evaluation may be performed based on detecting that there is space in the context length to add additional tokens (e.g., due to a current offloading event), passage of a certain amount of time since a prior evaluation for reintroducing offloaded tokens, and/or the like.

In some embodiments, the first token may be reintroduced based on determining that the first token has semantic relevance to one or more second tokens associated with the active context. In this regard, the trigger may be a threshold level of semantic relevance. Semantic relevance may be determined by computing a cosine similarity between the embedding of the first token and the embeddings of the one or more second tokens in the active context. Other distance metrics other than cosine similarity may also be used.

In act 510, the context monitor 212 retrieves the stored first representation of the first token from the storage device 102.

In act 512, the first representation of the first token is combined (e.g., concatenated) with the one or more second representations of the one or more second tokens. In some embodiments, the context monitor 212 recomputes the attention score for the first token and the one or more second tokens based on their representations.

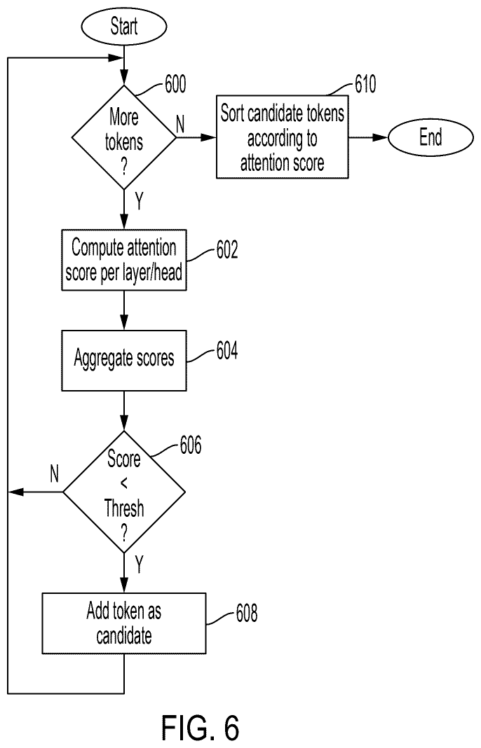

FIG. 6 depicts a flow diagram of a process for selecting candidate tokens for offloading based on importance according to one or more embodiments. The process starts, and in act 600 a determination is made as to whether there are more tokens to be evaluated for offloading. In this regard, the tokens in the current context length are examined.

In act 602, one or more attention scores are computed for the token across one or more attention heads and/or one or more transformer layers 202 of the LLM 200.

In act 604, the computed attention scores for the token are aggregated for a total attention score of the token.

In act 606, a determination is made as to whether the total attention score is less than a threshold score. The threshold score may be set as a hyperparameter of the LLM 200.

If the answer is YES, the token as added, in act 608, as a possible candidate for offloading.

Referring again to act 600, if there are no more tokens to be evaluated, the tokens selected as candidates for offloading are sorted according to their attention scores in act 610. In some embodiments, the candidate tokens with the higher attention scores are stored in the fast memory 110 and the remaining candidate tokens are stored in the slow memory 112.

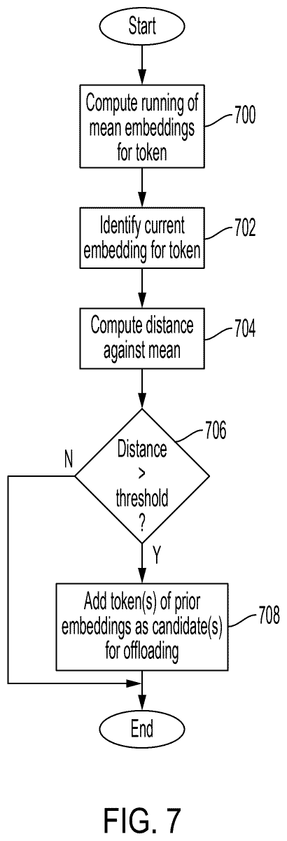

FIG. 7 depicts a flow diagram of a process for computing drift of a token according to one or more embodiments. In some embodiments, a running mean of an embedding of a token is computed in act 700. The running mean may show accumulated drift of the token over time, highlighting semantic shift relative to origin. The running mean may be updated each time the token is identified during an interaction. For example, the token may be “key,” and each time the word “key” is identified during the interaction, an embedding for “key” may be added to the running mean.

In act 702, a current embedding for the token is identified. For example, the current embedding may be based on a most recent input query to the LLM 200.

In act 704, the context monitor 212 computes a similarity distance between the current embedding and the mean embedding based on prior occurrences of the token.

In act 706, the context monitor 212 determines whether the distance is greater than a threshold distance. Such a distance may signify a semantic shift in the meaning of the token. For example, the word “key” may have been used to refer to a tool for unlocking a door in prior occurrences of the interaction, but may now be used to mean a solution to problem. In this case, the similarity distance between the two embeddings may be greater than the threshold distance. In some embodiments, the threshold distance may be configured as a hyperparameter of the LLM 200.

In act 708, the prior occurrence(s) of the token may be added as candidate(s) for offloading.

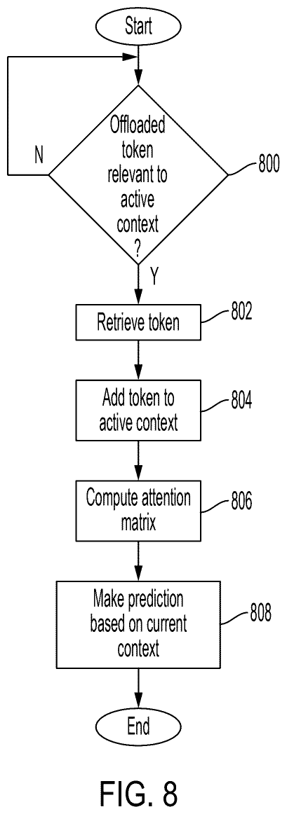

FIG. 8 depicts a flow diagram of a process for reintegrating an offloaded token back into the active context or context length according to one or more embodiments. The process starts, and in act 800, a determination is made as to whether an offloaded token is relevant to the active context. Determination as to whether the offloaded token is relevant may be based on a comparison of the offloaded token to one or more tokens in the active context. If a similarity distance between the embedding of the offloaded token and the embedding of a token in the active context is smaller than a threshold, the offloaded token may be deemed to be relevant.

If the token is deemed to be relevant, the offloaded token is retrieved from the storage device 102 in act 802. In this regard, the context monitor 212 may issue a load or read command to the storage device 102 along with an identifier of the token to be retrieved. The storage device 102 may return the embedding of the token and associated metadata, including a prior attention score of the token.

In act 804, the embedding of the retrieved token is added to the active context. In some embodiments, the embedding of the retrieved token is concatenated with the embedding of the other tokens in the active context.

In act 806 the attention matrix of the tokens in the active context with the retrieved token added is computed in act 806. That is, the old attention score of the offloaded token may no longer be accurate and may need to be updated based on the tokens in the active context.

In act 808, the LLM uses the embeddings in the active context to make predictions based on user inputs. The predictions may be, for example, predicted text, images, sound, and/or the like, that is responsive to the user inputs.

As a person of skill in the art should appreciate, the offloading and reloading of tokens provides or emulates a longer context text than the physical context length limit imposed by the LLM. The longer context length allows the LLM to more accurately answer questions relating to relatively older data in terms of the context of the conversation, allowing the model to handle more extensive prompts or dialogues in a more accurate manner. Having the longer context may further allow applications where the longer context may be useful, such as when summarizing books, writing code based on detailed instructions, or reasoning over long documents, without the need to physically increase the allowed context length.

One or more embodiments of the present disclosure may be implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for increasing the context length of a language model have been specifically described and illustrated herein, many modifications and variations will be apparent to those skilled in the art. Accordingly, it is to be understood that systems and methods for increasing the context length of a language model constructed according to principles of this disclosure may be embodied other than as specifically described herein. The disclosure is also defined in the following claims, and equivalents thereof.

The systems and methods for increasing the context length of a language model may contain one or more combination of features set forth in the below statements.

Statement 1: A system comprising: a processor; a storage device; and a memory, wherein the memory stores instructions that, when executed by the processor, cause the processor to: identify a first token associated with a language model; detect importance of the first token being below a threshold importance; detect a semantic shift of the first token; store a first representation of the first token in the storage device based on determining the importance of the first token and further based on identifying the semantic shift; detect a trigger; retrieve the first representation of the first token from the storage device based on detecting the trigger; and combine the first representation of the first token with one or more second representations of one or more second tokens associated with an active context.

Statement 2. The system of Statement 1, wherein the storage device includes a first type of storage medium and a second type of storage medium slower than the first type of storage medium, wherein the instructions further cause the processor to store the first token to the first type of storage medium and a third token to the second type of storage medium based on determining higher importance of the first token relative to the third token.

Statement 3. The system of Statement 1, wherein the first representation of the first token includes a vector representation of the first token for identifying relationship of the first token relative to one or more third tokens.

Statement 4. The system of Statement 1, wherein the instructions that cause the processor to determine the importance of the first token include instructions that cause the processor to calculate an attention score for the first token based on the first representation of the first token.

Statement 5. The system of Statement 4, wherein the attention score for the first token is based on a first attention score generated by a first portion of the language model and a second attention score generated by a second portion of the language model.

Statement 6. The system of Statement 5, wherein the first portion and the second portion include a first layer and a second layer of the language model.

Statement 7. The system of Statement 5, wherein the first portion and the second portion include a first attention head and a second attention head of the language model.

Statement 8. The system of Statement 1, wherein the instructions that cause the processor to identify the semantic shift include instructions that cause the processor to: compute a distance between the first representation of the first token associated with a first portion of an interaction, and a second representation of a third token associated with a second portion of the interaction; and determine that the distance is greater than a threshold distance.

Statement 9. The system of Statement 1, wherein the trigger includes a determination that the first token has semantic relevance to the one or more second tokens associated with the active context.

Statement 10. The system of Statement 1, wherein the instructions further cause the processor to: based on combining the first representation of the first token, compute an attention score for the first token based on the one or more second representations and the first representation.

Statement 11. A method comprising: identifying, by a processor, a first token associated with a language model; detecting, by the processor, importance of the first token being below a threshold importance; detecting, by the processor, a semantic shift of the first token; storing, by the processor, a first representation of the first token in a storage device coupled to the processor based on determining the importance of the first token and further based on identifying the semantic shift; detecting, by the processor, a trigger; retrieving, by the processor, the first representation of the first token from the storage device based on detecting the trigger; and combining, by the processor, the first representation of the first token with one or more second representations of one or more second tokens associated with an active context.

Statement 12. The method of Statement 11, wherein the storage device includes a first type of storage medium and a second type of storage medium slower than the first type of storage medium, the method further comprising: storing the first token to the first type of storage medium and a third token to the second type of storage medium based on determining higher importance of the first token relative to the third token.

Statement 13. The method of Statement 11, wherein the first representation of the first token includes a vector representation of the first token for identifying relationship of the first token relative to one or more third tokens.

Statement 14. The method of Statement 11, wherein the determining of the importance of the first token includes calculating an attention score for the first token based on the first representation of the first token.

Statement 15. The method of Statement 14, wherein the attention score for the first token is based on a first attention score generated by a first portion of the language model and a second attention score generated by a second portion of the language model.

Statement 16. The method of Statement 15, wherein the first portion and the second portion include a first layer and a second layer of the language model.

Statement 17. The method of Statement 15, wherein the first portion and the second portion include a first attention head and a second attention head of the language model.

Statement 18. The method of Statement 11, wherein the identifying of the semantic shift includes: computing, by the processor, a distance between the first representation of the first token associated with a first portion of an interaction, and a second representation of a third token associated with a second portion of the interaction; and determining, by the processor, that the distance is greater than a threshold distance.

Statement 19. The method of Statement 11, wherein the trigger includes a determination that the first token has semantic relevance to the one or more second tokens associated with the active context.

Statement 20. The method of Statement 11 further comprising: based on combining the first representation of the first token, computing, by the processor, an attention score for the first token based on the one or more second representations and the first representation.

What is claimed is:

1. A system comprising:
a processor;
a storage device; and
a memory, wherein the memory stores instructions that, when executed by the processor, cause the processor to:
identify a first token associated with a language model;
detect importance of the first token being below a threshold importance;
detect a semantic shift of the first token;
store a first representation of the first token in the storage device based on determining the importance of the first token and further based on identifying the semantic shift;
detect a trigger;
retrieve the first representation of the first token from the storage device based on detecting the trigger; and
combine the first representation of the first token with one or more second representations of one or more second tokens associated with an active context.

2. The system of claim 1, wherein the storage device includes a first type of storage medium and a second type of storage medium slower than the first type of storage medium, wherein the instructions further cause the processor to store the first token to the first type of storage medium and a third token to the second type of storage medium based on determining higher importance of the first token relative to the third token.

3. The system of claim 1, wherein the first representation of the first token includes a vector representation of the first token for identifying relationship of the first token relative to one or more third tokens.

4. The system of claim 1, wherein the instructions that cause the processor to determine the importance of the first token include instructions that cause the processor to calculate an attention score for the first token based on the first representation of the first token.

5. The system of claim 4, wherein the attention score for the first token is based on a first attention score generated by a first portion of the language model and a second attention score generated by a second portion of the language model.

6. The system of claim 5, wherein the first portion and the second portion include a first layer and a second layer of the language model.

7. The system of claim 5, wherein the first portion and the second portion include a first attention head and a second attention head of the language model.

8. The system of claim 1, wherein the instructions that cause the processor to identify the semantic shift include instructions that cause the processor to:
compute a distance between the first representation of the first token associated with a first portion of an interaction, and a second representation of a third token associated with a second portion of the interaction; and
determine that the distance is greater than a threshold distance.

9. The system of claim 1, wherein the trigger includes a determination that the first token has semantic relevance to the one or more second tokens associated with the active context.

10. The system of claim 1, wherein the instructions further cause the processor to:
based on combining the first representation of the first token, compute an attention score for the first token based on the one or more second representations and the first representation.

11. A method comprising:
identifying, by a processor, a first token associated with a language model;
detecting, by the processor, importance of the first token being below a threshold importance;
detecting, by the processor, a semantic shift of the first token;
storing, by the processor, a first representation of the first token in a storage device coupled to the processor based on determining the importance of the first token and further based on identifying the semantic shift;
detecting, by the processor, a trigger;
retrieving, by the processor, the first representation of the first token from the storage device based on detecting the trigger; and
combining, by the processor, the first representation of the first token with one or more second representations of one or more second tokens associated with an active context.

12. The method of claim 11, wherein the storage device includes a first type of storage medium and a second type of storage medium slower than the first type of storage medium, the method further comprising:
storing the first token to the first type of storage medium and a third token to the second type of storage medium based on determining higher importance of the first token relative to the third token.

13. The method of claim 11, wherein the first representation of the first token includes a vector representation of the first token for identifying relationship of the first token relative to one or more third tokens.

14. The method of claim 11, wherein the determining of the importance of the first token includes calculating an attention score for the first token based on the first representation of the first token.

15. The method of claim 14, wherein the attention score for the first token is based on a first attention score generated by a first portion of the language model and a second attention score generated by a second portion of the language model.

16. The method of claim 15, wherein the first portion and the second portion include a first layer and a second layer of the language model.

17. The method of claim 15, wherein the first portion and the second portion include a first attention head and a second attention head of the language model.

18. The method of claim 11, wherein the identifying of the semantic shift includes:
computing, by the processor, a distance between the first representation of the first token associated with a first portion of an interaction, and a second representation of a third token associated with a second portion of the interaction; and
determining, by the processor, that the distance is greater than a threshold distance.

19. The method of claim 11, wherein the trigger includes a determination that the first token has semantic relevance to the one or more second tokens associated with the active context.

20. The method of claim 11 further comprising:
based on combining the first representation of the first token, computing, by the processor, an attention score for the first token based on the one or more second representations and the first representation.
